(19) United States
(12) Patent Application Publication
(10) Pub. No.: US 2010/0215448 A1
(43) Pub. Date: Aug. 26, 2010

(54) METHOD OF MACHINING A SUBSTRATE

(76) Inventors: Cornelius Johannes Pretorius, Co. Clare (IE); Peter Michael Harden, Limerick (IE)

Correspondence Address: FROMMER LAWRENCE & HAUG, 745 FIFTH AVENUE- 10TH FL., NEW YORK, NY, 10151, US

(21) Appl. No.: 12/527,529

(22) PCT Filed: Feb. 28, 2008
(86) PCT No.: PCT/IB2008/050716

§ 371 Date: Mar. 4, 2010

(30) Foreign Application Priority Data
Feb. 28, 2007 (ZA) 2007/01779

(51) Int. Cl. B23B 35/00; B23D 43/02; B23C 5/00; B23B 1/00; B23D 37/00

(52) U.S. Cl. 408/1 R; 83/13; 409/131; 82/1.11

(57) ABSTRACT

The invention provides for a method of machining a substrate which includes the step of machining the substrate in an interrupted machining, impact machining or combination thereof operation using a tool which includes a tool component comprising a layer of polycrystalline diamond (12) having a working surface (16), a softer layer (20) containing a metal and bonded to the working surface (16) of the polycrystalline diamond layer (12) along an interface, the region (22) of the layer of polycrystalline diamond (12) adjacent the interface containing some metal from the softer layer (20).

### BACKGROUND OF THE INVENTION

This invention relates to a method of machining a substrate.

Ultra-hard abrasive cutting elements or tool components utilizing diamond compacts, also known as polycrystalline diamond (PCD), and cubic boron nitride compacts, also known as PCBN, are extensively used in drilling, milling, cutting and other such abrasive applications. The element or tool component will generally comprise a layer of PCD or PCBN bonded to a support, generally a cemented carbide support. The PCD or PCBN layer may present a sharp cutting edge or point or a cutting or abrasive surface.

PCD comprises a mass of diamond particles containing a substantial amount of direct diamond-to-diamond bonding. PCD will typically have a second phase containing a diamond catalyst/solvent such as cobalt, nickel, iron or an alloy containing one or more such metals. PCBN will generally also contain a bonding phase which is typically a cBN catalyst or contain such a catalyst. Examples of suitable bonding phases are aluminium, alkali metals, cobalt, nickel, tungsten and the like.

PCD cutting elements are widely used for machining a range of metals and alloys as well as wood composite materials. The automotive, aerospace and woodworking industries in particular use PCD to benefit from the higher levels of productivity, precision and consistency it provides. Aluminium alloys, bi-metals, copper alloys, carbon/graphite reinforced plastics and metal matrix composites are typical materials machined with PCD in the metalworking industry. Laminated flooring boards, cement boards, chipboard, particle board and plywood are examples of wood products in this class. PCD is also used as inserts for drill bodies in the oil drilling industry.

Failure of a cutting tool during machining is usually brought about by one or a combination of the following processes:
By catastrophic fracture (sudden failure)
By cumulative wear (progressive failure)
By plastic deformation (sudden failure)

Plastic Deformation leading to shape changes is usually not a very significant factor in ultra-hard cutting tool materials, like PCD, which maintains its strength at elevated temperatures. The failure of a tool due to progressive wear is characterised by the development of wear features on the tool. Typical wear features include flank wear, crater wear, DOC (depth of cut) notch wear, and trailing edge notch wear. The width of the flank wear land (VB_{B}max) is a suitable tool wear measure and a predetermined value of VB_{B}max is regarded as a good tool life criteria [INTERNATIONAL STANDARD (ISO) 3685, 1993, Tool life testing with single point turning tools]. The wear modes causing the wear features (wear scars) in a particular application is generally dependent on the cutting tool microstructure, the machining conditions and the geometry of the cutting edge. Wear modes can include abrasive wear, wear by microfracture (chipping, spelling and cracking), adhesive wear (built-up edge formation) or tribochemical wear (diffusion wear and formation of new chemical compounds). A great amount of time and effort is normally spent on finding the optimum tool material, geometry and machining parameters.

The high hardness of diamond is responsible for its good wear characteristics of PCD, however, negatively affect its fracture or chip resistance. This low chip resistance of PCD could cause catastrophic fracture or wear by a micro-fracture wear mode while the tool stays in the break-in stage or early stage in use in certain application. In order to prevent catastrophic fracture, chamfers and hones are usually produced on the cutting edges in order to increase its strength.

The lower chip resistance of PCD compared to carbide has restricted its use to only finishing application. In roughing and severe interrupted applications (high feed rate and depth of cut), where the load on the cutting edge is higher, PCD can easily fracture causing the tool to fail pre-maturely. Carbide on the other hand wears quicker than PCD, but is more chip resistant. Unlike in finishing operations, dimensional tolerance is not so critical in roughing operation (VB_{B}max >0.6) which means that tool wear is not the dominant factor, but rather chip resistance. Also, in less severe applications, like MDF (medium density fibre board) low SiAl-alloys and chipboard, the wear rate is generally lower, and carbide is therefore preferred as a result of a lower cost-to-performance ratio.

In addition to this, due to the high hardness of PCD processing cost can be high, making it even less attractive when compared to carbide. Ultra-hard cutting tool materials (Polycrystalline Diamond (PCD), Polycrystalline Cubic Boron Nitride (PCBN), Single Crystal Diamond etc.), produced by high-temperature-high-pressure (HPHT) synthesis, have to go through several processing steps before they can be used as inserts for cutting tools. These processing steps generally involve the following:
1) Removal of a metal cup, usually a tantalum or niobium or molybdenum cup, from the ultra hard abrasive surface and sides of the synthesised discs
2) Bulk removal of outer portion of ultra hard abrasive table to obtain preferred characteristics
3) Semi-finishing on the top surface
4) Polishing (finishing) on the top surface. Typically a polished PCD layer has a roughness of Ra=0.01 μm as measured with a 90°, 3 μm stylus. PCBN is generally not polished
5) Cutting a disc into segments. Both disc and cut segments are supplied into the market. Of all these processing steps, polishing is probably the most problematic due to the ultra hard nature of the abrasive material. Generally, a high quality surface finish of the abrasive layer is required in application to enhance its performance.

Another disadvantage of currently available PCD cutting tools is that they are not designed to machine ferrous materials. When machining cast irons for example, the cutting forces and thus the cutting temperature at the cutting edge are much higher compared to non-ferrous machining. Since PCD starts to graphitise around 700° C., it limits its use to lower cutting speeds when machining ferrous materials, rendering it un-economical in certain applications compared to carbide tools.

U.S. Pat. No. 5,833,021 discloses a polycrystalline diamond cutter having a refractory coating applied to the polycrystalline diamond surface to increase the operational life of the cutter. The refractory layer has a thickness of 0.1 to 30 microns and is applied in a post-synthesis operation, e.g. plating or chemical or physical deposition.

U.S. Pat. No. 6,799,951 discloses a drill insert for a twist drill comprising a polycrystalline diamond layer and a layer of molybdenum is applied to a surface thereof through another metal layer. The other metal layer may be niobium, tantalum, zirconium, tungsten and other similar such metals or alloys containing such metals. There is no suggestion that the drill insert can be used for any other application.

U.S. Pat. No. 6,439,327 discloses a polycrystalline diamond cutter for a rotary drill in which a side surface of the cutter is provided with a metal layer high pressure bonded to the side surface of the polycrystalline diamond. An example of a suitable metal is molybdenum.

An article “Development of New PDC Bits for Drilling of Geothermal Wells—Part 1: Laboratory Testing by H Karasawa and S. Misawa, Journal of Energy Resources Technology, December 1992, Vol 114, 323, describes a PDC cutter comprising a diamond layer to which a titanium carbide layer is applied. The thickness of the layer is 0.2 to 0.3 mm. The coating is said to prevent chipping of the diamond layer.

U.S. Pat. No. 3,745,623 discloses the manufacture of PCD in a titanium or zirconium protective sheath, some of which is converted to carbide during manufacture. A thin layer of this titanium or zirconium sheath may be left on the PCD over the chip breaker face.

### SUMMARY OF THE INVENTION

The invention provides a method of machining a substrate including the step of machining a substrate in an interrupted machining, impact machining or combination thereof operation using a tool which includes a tool component comprising a layer of polycrystalline diamond having a working surface, a softer layer containing a metal and bonded to the working surface of the polycrystalline diamond layer along an interface and the region of the layer of polycrystalline diamond adjacent the interface containing some metal from the softer layer.

The softer layer provides a layer softer than the polycrystalline diamond for the tool component. This softer layer is strongly bonded to the working surface of the polycrystalline by virtue of the fact that some of the metal has diffused into the region of the polycrystalline diamond adjacent the interface with the softer layer and is present in this region of the polycrystalline diamond. Some of the metal present as a second phase in the polycrystalline diamond will also have diffused into the softer layer. Thus, the bond between the softer layer and the polycrystalline diamond is, in essence, a diffusion bond. Such a bond may be produced, for example, during the manufacture of the polycrystalline diamond, i.e. the softer layer is created and bonded to the polycrystalline diamond in situ during such manufacture. Such a strong bond is not achievable using a post-synthesis coating or deposition method such as that described in U.S. Pat. No. 5,883,021 where delamination of the carbide layer is likely to occur under severe conditions.

It has been found that the provision of a softer top layer to the diamond material improves the performance of the tool component in a method of machining a substrate employing interrupted and/or impact machining applications. Typical applications of such machining are milling, sawing and reaming of composites (including wood), aluminium-alloys, cast irons, titanium alloys, heat resistant superalloys (HRSA) and hardened steels. Another application of impact machining is in drilling for oil and gas. In this application the drill bit has to drill through various types of rock formations (with different properties) resulting in impact loading on the cutting edge. Bit whirl will also result in impact loading on the cutting edge. Certain turning applications may also require interrupted or impact machining. One such application is the turning of hardened steels with PCBN. In this application a crater forms on the rake face of the tool resulting in a smaller wedge angle which in turn reduces the strength of the cutting edge. In the past industry has tried to compensate for this by applying a chamfer and a hone on the cutting edge and by doing so increased the wedge angle of the insert. Two other turning applications where interrupted or impact resistance may be required is the turning of titanium and heat resistant superalloys where there is a tendency for notches to form on the cutting edge. In the past industry has compensated for this by increasing the nose radius or by changing the approach angle of the insert.

The metal of the softer layer may be any one of a variety of metals, but is preferably a transition metal. Examples of suitable transition metals are molybdenum, hafnium, chromium, niobium, tantalum, titanium and tungsten. Nickel and copper of the transition metals and platinum are also believed to be particularly suitable metals for the practice of the invention.

The metal of the softer layer may be present as metal, metal carbide, nitride, boride, silicide, or carbonitride or a combination of two or more thereof. The metal of the softer layer is preferably present as metal, metal carbide or a combination thereof. More preferably, the softer layer consists predominantly of a metal in carbide form and a minor amount of the metal, as metal, and metal from the polycrystalline diamond, i.e. metal such as cobalt which is present as a second phase in the polycrystalline diamond.

The softer layer may extend across a portion of the working surface only or across the entire working surface.

The working surface of the polycrystalline diamond layer is preferably the top surface of such layer and intersects another surface of the layer defining a cutting point or edge at the intersection. The softer layer preferably extends from the cutting edge or point across at least a portion of the working surface.

The thickness of the softer layer will vary according to the nature of the machining operation being carried out and the nature of the substrate. Generally, the softer layer has a thickness of up to 100 microns. The softer layer preferably has a thickness of at least 50 microns. A preferred thickness for drilling of rock formations is 200 to 300 microns.

The softer layer bonded to the working surface of the polycrystalline diamond layer in the tool component of the invention may be produced in situ in the manufacture of the tool component. In such a method, the components for producing the polycrystalline diamond layer are placed in a metal cup or capsule which is then subjected to the conditions of elevated temperature and pressure required to produce the polycrystalline diamond. Some of this metal cup or capsule adheres to and bonds to the outer surface of the polycrystalline diamond during manufacture. Alternatively a layer of the metal which is intended to form the softer layer may be placed in contact with the unbonded diamond particles in the capsule or cup. Some of the metal from the capsule, cup or layer will diffuse into the polycrystalline diamond, during manufacture. Similarly, some metal from the polycrystalline diamond, e.g. cobalt, will diffuse into the softer layer.

The working surface of the diamond layer may be smooth, polished or rough or irregular. When the working surface is rough or irregular, such may be that resulting from subjecting the working surface to a sandblasting or similar process.

The top, exposed surface of the softer layer may be polished. Polishing the softer layer is obviously considerably easier than polishing a surface of the diamond layer.

The layer of polycrystalline diamond is preferably bonded to a substrate or support. The substrate is preferably a cemented carbide substrate. The carbide of the substrate is preferably tungsten carbide, tantalum carbide, titanium carbide or niobium carbide. Ultra-fine carbide is preferably used in making the cemented carbide by methods known in the art.

### BRIEF DESCRIPTION OF THE DRAWINGS

FIG. 1 is a sectional side view of a portion of an embodiment of a tool component for use in the method of the invention;

FIG. 2 is a partially sectioned schematic drawing of a encapsulated pre-form for making a tool component for use in the method of the invention, and

FIG. 3 is a micrograph of a softer top layer bonded to a layer of polycrystalline diamond illustrating various regions thereof.

### DESCRIPTION OF PREFERRED EMBODIMENTS

The invention thus provides an improved method to machine a substrate in an interrupted and/or impact machining operation using improved tool component. Other advantages which flow from the softer layer bonded to the working surface of the polycrystalline diamond layer are:

A softer layer bonded to the harder abrasive layer results in a self-rounding or self-honing effect of the cutting edge in the initial stages of wear. This in turn will increase the strength of the cutting edge and reduce the break-in wear stage. The degree of rounding can be controlled by either increasing or decreasing the hardness of the softer layer. The material of the layer will also fill the pores and pits at the edge of the polycrystalline diamond layer resulting in less wear initiation sites. After the initial rounding process, the softer top layer can wear into the shape of a chip breaker.

A polished softer top layer will result in fewer flaws on the working surface as compared to prior art polycrystalline diamond products. The softer layer will also deform quickly to provide a stronger more rounded edge during the initial stages of cutting. Metal layers will generally also have a higher fracture toughness as compared to polycrystalline diamond. A less aggressive polishing method will result in lower stresses in the polycrystalline diamond surface. All these factors will reduce the frequency and severity of spalling, chipping and cracking, particularly in interrupted and/or impact machining of substrates.

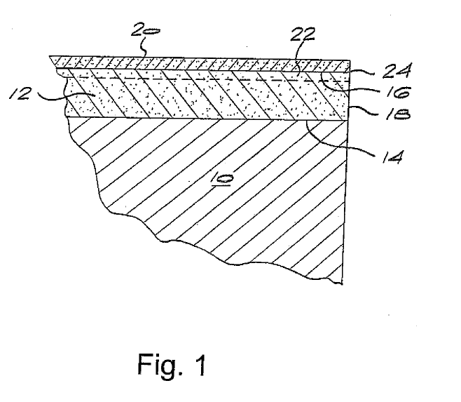

The invention will now be described with reference to FIG. 1 of the accompanying drawings. FIG. 1 illustrates the cutting edge portion of a tool component which may be used in a method of machining a substrate employing interrupted and/or impact machining in accordance with the invention.

Referring to FIG. 1, a tool component used in the method of the invention comprises a cemented carbide substrate 10 to which is bonded a layer polycrystalline diamond 12 along interface 14. The layer of polycrystalline diamond 12 has an upper surface 16 which is the working surface of the tool component. The surface 16 intersects side surface 18 along a line which defines a cutting edge for the tool component.

A softer layer 20 is bonded to the working surface 16. This softer layer 20 extends to a cutting edge 18. The softer layer 20 is of the type described above and contains a metal. Some of this metal from the layer 20 will be present in the region 22 in the polycrystalline diamond layer indicated by the dotted lines. Some metal from the polycrystalline diamond layer 12 will be present in the softer layer 20. Thus, a diffusion bond exists between the softer layer 20 and the polycrystalline diamond layer 12.

The invention is further illustrated by the following Examples.

### EXAMPLE 1

A mass of diamond particles was placed on a surface of a cemented carbide substrate having cobalt as the binder phase. This unbonded mass was placed in a molybdenum capsule and this capsule placed in the reaction zone of a conventional high pressure/high temperature apparatus. The contents of the capsule were subjected to a temperature of about 1400° C. and a pressure of about 5 GPa. These conditions were maintained for a time sufficient to produce a layer of polycrystalline diamond having a surface bonded to the cemented carbide substrate and an opposite exposed surface. The layer of polycrystalline diamond had a second phase containing cobalt.

The capsule was removed from the reaction zone. A layer of molybdenum/molybdenum carbide was bonded to the outer surface of the polycrystalline diamond. The outer regions of this layer of molybdenum/molybdenum carbide were removed by grinding leaving a thin layer of a material softer than the polycrystalline diamond bonded to one of the major surfaces of the layer of polycrystalline diamond.

The softer layer had a thickness of 100 microns. Analysis using EDS showed that this softer layer consisted predominantly of molybdenum carbide and a minor amount of molybdenum metal and cobalt from the cemented carbide substrate. The region of the polycrystalline diamond adjacent the interface with the softer layer was found to contain molybdenum, using the same EDS analysis. The bond between the softer layer and the polycrystalline diamond layer was strong. A plurality of cutting tool components were produced from the carbide supported polycrystalline diamond, such cutting tool inserts having a structure as illustrated by the accompanying drawing. These cutting tool components were found in tests to be effective in wood working and metal working applications. No delamination of the softer layers occurred.

### EXAMPLE 2

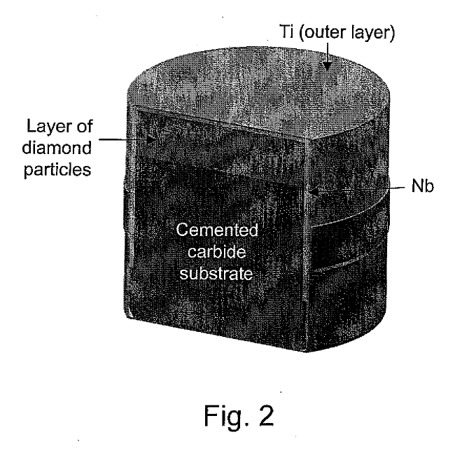

A mass of diamond particles was placed on a surface of a cemented carbide substrate having cobalt as the binder phase. The diamond particles had a mean size, in terms of equivalent diameter, of about 6 microns (measured using a Malvern Mastersizer), with the majority of the particles being greater than about 2 microns and less than about 22 microns. This unbonded mass was placed in a niobium capsule, the average wall thickness of which was about 250 microns, which capsule was itself placed within a titanium capsule, with average wall thickness of about 150 microns. This doubly-encapsulated reaction mass was placed in the reaction zone of a conventional high pressure/high temperature apparatus. The contents of the capsule were subjected to a temperature of about 1400° C. and a pressure of about 5 GPa. These conditions were maintained for a time sufficient to produce a layer of polycrystalline diamond having a surface bonded to the cemented carbide substrate and an opposite exposed surface. The pressure and temperature cycle was one typically employed for the sintering of PCD cutters for rock drilling in the oil and gas industries. The layer of polycrystalline diamond had a second phase containing cobalt. The diamond and carbide substrate used in this example, in terms of both composition and dimension, were those typically used in the manufacture of PCD inserts suitable for oil and gas drilling bits. A schematic diagram of the encapsulated pre-form (i.e. before being subject to high temperatures and pressures) is shown in FIG. 2.

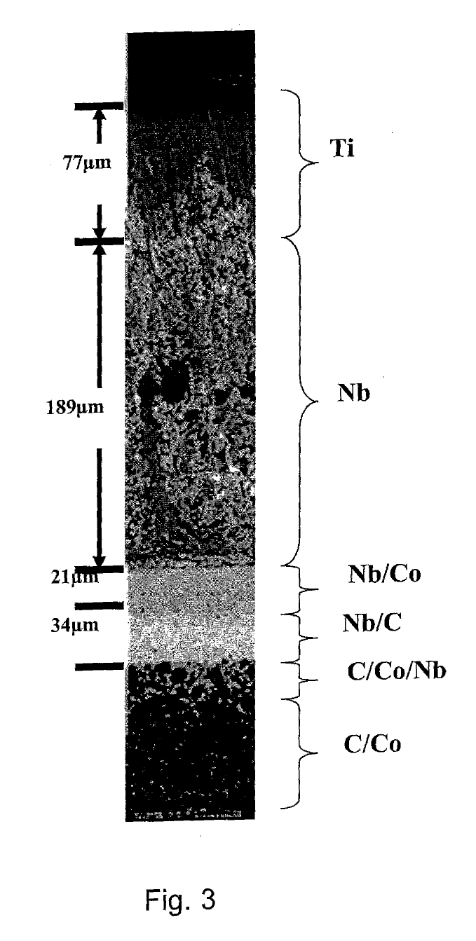

The capsule was removed from the reaction zone. A first layer comprising niobium/niobium carbide and cobalt was bonded to the outer surface of the polycrystalline diamond. This layer had an approximate thickness of 55 microns, and itself comprised at least two layer portions, the portion closest to the PCD layer being relatively richer in carbon than that further away from the PCD layer. A second layer with approximate thickness of 189 microns and comprising principally niobium metal was bonded to the first layer. A third layer with approximate thickness of 77 microns and comprising principally titanium was bonded to the second layer. A relatively thinner layer comprising both titanium and niobium metal was observed between the substantially niobium second layer and the substantially titanium third layer. The observed layer structure is shown in FIG. 3, wherein the PCD layer is indicated by the label “C/Co” (i.e. diamond and cobalt).

The outer regions of the layer of titanium were removed by grinding leaving a layer of a material softer than the polycrystalline diamond bonded to one of the major surfaces of the layer of polycrystalline diamond. Four PCD cutter inserts thus coated were made and a different thickness of the outer regions softer coating of each was ground off, leaving components with the following thicknesses of niobium: 0 microns (i.e. where the softer layer was removed by grinding to the point where the outer most diamond of the PCD layer was only just exposed), 10 microns, 50 microns and 150 microns. None of the inserts were chamfered at the edges of the working portion and no delamination of the softer layers occurred. These inserts were comparatively tested by means of a sandstone milling test operation, which is suitable for determining figures of merit indicative of their likely relative performances in certain kinds of rock drilling. This test involves the milling of a sandstone workpiece and the figure of merit is defined as the total sliding distance milled until the insert fails to the point where there is no longer any meaningful milling action. The sandstone used was so-called Naboomspruit sandstone and the milling conditions were as follows:
Spindle speed of 1140 rpm
Depth of cut set to 2.5 mm
50% interrupt (i.e. the cutter milled a half-circle area of the workpiece, the cutter spending 50% of the time engaged in cutting action and 50% not so engaged, as it rotated repeatedly into and out of this action).

It was found that the “distance to failure” figure of merit increased monotonically as a function of the thickness of the softer layer, and the figure of merit in the case of the 150 micron thick softer layer was almost double that of the insert with the entire softer layer removed. The distance to failure for each of the four inserts, rounded to the nearest 50 mm) is shown in Table 1.

TABLE 1

| Softer layer thickness (microns) | Distance to failure (mm) |
|---|---|
| 0 | 2,700 |
| 10 | 3,250 |
| 50 | 3,900 |
| 150 | 6,900 |

Another four inserts essentially identical to those described above (i.e. with softer layers having thicknesses of 0, 10, 50 and 150 microns, respectively) were made in the same way and were subjected to two different wear tests, using opposite ends of the working portion of each insert (i.e. two wear tests were carried out using each insert such that the effects of each test did not interfere with those of the other). The first wear test involved so-called vertical turret lathe-machining (alternatively called the “vertical borer test”) of Paarl granite, a very abrasive, hard and inhomogeneous type of rock, and the second involved lathe-machining Paarl granite. The wear figure of merit in these tests is the depth of the wear scar arising in the PCD layer as a result of removing a given volume of workpiece material. The wear scar depth was measured after removing specific, incremental volumes of workpiece material, up to a maximum of about 0.5×10⁻³ m³. No systematic difference in wear figure of merit, within the error bars, was observed between the inserts with different softer layer thicknesses. It is worth mentioning that the continuous-mode machining of granite has similarities with interrupted cutting due to the inhomogeneous composition and structure of granite, which comprises a conglomerate of different kinds of rock particles with different hardnesses. The effect on the PCD cutter has parallels with that of very high frequency interrupted/impactive mode machining.

This example showed that the PCB with the softer layer resulted in improved PCD cutter life in a heavily interrupted (and therefore impactive) milling operation, with no apparent decrease in continuous-mode machining of highly abrasive materials.

### EXAMPLE 3

Another set of PCD cutter inserts were manufactured and tested as in example 2, except that the mean size of the diamond particles was about 12 microns, with most of the particles being greater than about 2 microns and less than about 25 microns in size. The sandstone milling test results are shown in Table 2 (the distance to failure is rounded to the nearest 50 mm).

TABLE 2

| Softer layer thickness (microns) | Distance to failure (mm) |
|---|---|
| 0 | 2,600 |
| 10 | 2,900 |
| 50 | 4,550 |
| 150 | 4,800 |

The advantage of using a thicker softer layer is shown by these results.

Again, no systematic difference in wear performance was observed.

1. A method of machining a substrate includes the step of machining the substrate in an interrupted machining, impact machining or combination thereof operation using a tool which includes a tool component comprising a layer of polycrystalline diamond having a working surface, a softer layer containing a metal and bonded to the working surface of the polycrystalline diamond layer along an interface, the region of the layer of polycrystalline diamond adjacent the interface containing some metal from the softer layer.

2. A method according to claim 1 wherein the metal of the softer layer is a transition metal.

3. A method according to claim 1 wherein the metal of the softer layer is present as metal, metal carbide, nitride, boride, silicide or carbonitride or a combination of two or more thereof.

4. A method according to claim 1 wherein the softer layer consists predominantly of the metal in the form of the carbide and a minor amount of the metal, in metal form, and metal from the polycrystalline diamond.

5. A method according to claim 1 wherein the metal is selected from molybdenum, hafnium, chromium, niobium, tantalum, titanium and tungsten.

6. A method according to claim 1 wherein the softer layer has a thickness of up to 100 microns.

7. A method according to claim 1 wherein the softer layer covers a portion of the working surface only.

8. A method according to claim 1 wherein the softer layer covers the entire working surface.

9. A method according to claim 1 wherein the working surface is a top surface of the layer of polycrystalline diamond which intersects a side surface defining a cutting edge for the tool component at the intersection.

10. A method according to claim 9 wherein the softer layer extends from the cutting edge across at least a portion of the working surface.

11. A method according to claim 1 wherein the softer layer has a thickness of at least 50 microns.

12. A method according to claim 1 wherein the thickness of the softer layer is 200 to 300 microns.

13. A method according to claim 1 wherein the layer of polycrystalline diamond is bonded to a substrate.

14. A method according to claim 13 wherein the substrate is a cemented carbide substrate.

15. A method according to claim 1 wherein the machining is sawing, reaming, cutting, milling, turning or drilling.

16. (canceled)

17. (canceled)

18. A method according to claim 2 wherein the metal of the softer layer is present as metal, metal carbide, nitride, boride, silicide or carbonitride or a combination of two or more thereof.
